(19) United States
(12) Patent Application Publication
(10) Pub. No.: US 2003/0021242 A1
(43) Pub. Date: Jan. 30, 2003

(54) Method and system for providing a targeted electronic communication

(75) Inventors: Ian M. Drysdale, Coral Springs, FL (US); Charles A. Fillinger, Boca Raton, FL (US)

Correspondence Address: Paul M. Schwartz, SCHWARTZ & SCHWARTZ, P.L.C., Suite 200, 29623 Northwestern Highway, Southfield, MI, 48034, US

(73) Assignee: First Data Corporation

(21) Appl. No.: 09/812,036

(22) Filed: Mar. 19, 2001

(51) Int. Cl. H04Q 7/00

(52) U.S. Cl. 370/328

(57) ABSTRACT

A method for a facility communication system to provide a targeted electronic communication to a user having a personal wireless device comprising the steps of storing user specific information in a storage location, providing the personal wireless device with a transceiver device, recognizing the presence of the personal wireless device transceiver when the personal wireless device is within a predetermined distance from the facility communication system, sending a request for user specific information from the facility communication system to the personal wireless device, retrieving the user specific information, sending the user specific information from the personal wireless device to the facility communication system, comparing the user specific information to predetermined criteria and sending a targeted electronic communication to the personal wireless device corresponding to the user specific information

### TECHNICAL FIELD

This invention relates to a method and system for providing a electronic communication to a personal wireless device user and more particularly to a method and system for providing a targeted electronic communication to a personal wireless device user when the personal wireless device enters the proximity of a commercial facility.

### BACKGROUND ART

Historically, commercial merchants have utilized advertisements in written form to inform customers of current or up coming “sales” or price reductions in certain products. These advertisements are commonly provided in publicly circulated newspapers, in mass mailings or located directly at the store location. Similarly, coupons are commonly thought of as written documents that are presented to the merchant at the merchant location in exchange for a reduction in the purchase price of the goods or services.

In mass mailing and publicly circulated disseminations, it becomes obvious that a percentage, and sometimes a very large percentage of consumers do not utilize the advertisement information or the coupons. This may be for many reasons, but one common reason is the lack or correlation between the consumer and the products being offered in the advertisement or related to the coupon. As a more specific example, speciality merchants dealing in certain types of goods or services may lack the information to allow for targeted mailings. This lack of information or knowledge sometimes leads to over dissemination of the advertisement of coupons to insure adequate coverage of the appropriate population. Further, simple location may also contribute to the ineffectiveness of mass mailings and advertisements. These mass mailings are not always adequately targeted to the appropriate location due to wide dissemination of newspapers etc.

In addition to the concerns raised above with respect to written, hard copy advertisements and coupons, there exists a real time disconnect between the consumer, the merchant and real time inventory levels. Printed advertisements and coupons require preparation and printing time which detracts from the ability of the merchant to offer real time advertisements and coupons that correlate to the real time inventory levels of offered products. Combining time for preparation and printing with dissemination in mass mailings and newspapers often disconnects inventory from advertisements and coupons, creating the need for the “raincheck” system. A failure of a merchant to provide the merchandise which if offered or referred to in the advertisement of coupon creates disgruntled or unhappy consumers.

Consequently, a need has developed for a method and system for wirelessly sending targeted electronic coupons and advertisements to consumers which are received by the consumer via wireless devices such as a cellular phone, pager or personal digital assistant.

### DISCLOSURE OF INVENTION

It is the principal object of the present invention to provide a method and system for wirelessly sending an electronic communication to personal wireless device users upon entering the proximity of a predetermined location such as a commercial establishment.

It is a further object of the present invention to provide a method and system for wirelessly sending electronic coupons to consumers.

It is another object of the present invention to provide method and system for wirelessly sending electronic coupons to consumers as the consumers enter a commercial establishment.

It is a still further object of the present invention to provide a method and system for wirelessly sending electronic advertisements to consumers as the consumers enter a commercial establishment.

It is a yet another object of the present invention to provide a method and system for wirelessly sending targeted electronic coupons to consumers.

It is a still yet another object of the present invention to provide a method and system for wirelessly sending targeted advertisements to consumers.

It is a yet further an object of the present invention to provide a method and system for wirelessly sending targeted electronic coupons to consumers which can be used by the consumer via a wireless connection at the point of sale.

It is a still another object of the present invention to provide a method and system for wirelessly sending targeted electronic coupons and advertisements to consumers which are received by the consumer via wireless devices such as a cellular phone, pager or personal digital assistant.

It is still yet another object of the present invention to provide a method and system for obtaining information from a user having a personal wireless device, the method comprising the steps of providing a facility communication, providing the personal wireless device with a transceiver device and a means for accessing user specific information, recognizing the presence of the personal wireless device transceiver when the personal wireless device is within a predetermined distance from the facility communication system, sending a request for user specific information from the facility communication system to the personal wireless device and retrieving the user specific information.

In carrying out the above objects, there is provided a method for wirelessly sending an electronic communication to personal wireless device users upon entering the proximity of a predetermined location such as a commercial establishment. The method comprises the steps of storing user specific information in a storage location, providing the personal wireless device with a transceiver device, recognizing the presence of the personal wireless device transceiver when the personal wireless device is within a predetermined distance from the facility communication system, sending a request for user specific information from the facility communication system to the personal wireless device, retrieving the user specific information, sending the user specific information from the personal wireless device to the facility communication system, comparing the user specific information to predetermined criteria and sending a targeted electronic communication to the personal wireless device corresponding to the user specific information.

In carrying out the above method, there is provided a system that automates the above steps. The system provides a targeted electronic communication between a user and commercial establishment comprising a personal wireless device including a transceiver device and a facility communication system resident at the commercial establishment having a sensing device for recognizing the presence of the personal wireless device transceiver when the personal wireless device is within a predetermined distance from the facility communication system whereby the facility communication system sends a request for information to the personal wireless device when the sensing device senses the presence of the personal wireless device and the personal wireless device sends a response data message back to the facility communication system corresponding to the request for information and the facility communication system sends targeted electronic communication to the personal wireless device corresponding to response data message.

These and other objects, features, and advantages of the present invention will become more readily apparent by reference to the following description of the drawings wherein like reference numerals correspond to like components

### BRIEF DESCRIPTION OF DRAWINGS

FIG. 1 is a diagram of the system of the present invention; and

FIG. 2 is a flow diagram of the method of the present invention;

FIG. 3 is a flow diagram of an alternative embodiment of the method of the present invention;

FIG. 4 is a flow diagram of another alternative embodiment of the method of the present invention;

FIG. 5 is a flow diagram of yet another alternative embodiment of the method of the present invention;

FIG. 6 is a flow diagram of still another alternative embodiment of the method of the present invention; and

FIG. 7 is a flow diagram of a further alternative embodiment of the method of the present invention.

### BEST MODE FOR CARRYING OUT THE INVENTION

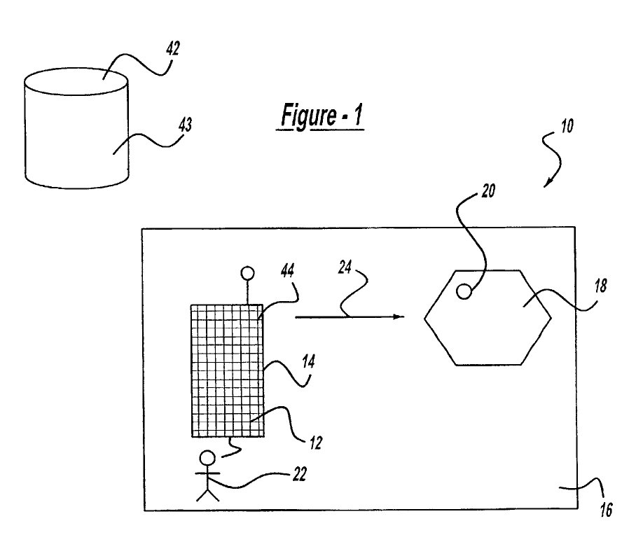

With reference to FIG. 1 of the drawings, there is shown a generalized schematic of the system 10 of the present invention. As discussed above, a personal wireless device 12 is shown having a transceiver device 14. The personal wireless device is for example, a cellular phone, a pager or a personal digital assistant. The present invention contemplates the use of any personal wireless device 12 that is capable or receiving and sending communication signals of some form and is capable of accepting and communicating with a transceiver 14.

Facility 16, in the preferred embodiment is a commercial establishment such as a common merchant. For example, the commercial establishment may be a retail clothing store. The facility 16 includes a facility communication system 18. The facility communication system is resident at the retail clothing store and includes a proximity sensor or sensing device 20 which is capable of recognizing the presence of the personal wireless device transceiver 14 when the personal wireless device 12 is within a predetermined distance from the facility communication system 18. This predetermined distance may be when user 22 moves within 0 to 1,500 meters of the sensing device 20. In the preferred embodiment, the predetermined distance will be any distance less than the distance from the sensing device to the closest entrance to the facility. More specifically, in the preferred embodiment, the sensing device will sense the presence of the transceiver 14 when the user 22 enters the facility 16 carrying the personal wireless device.

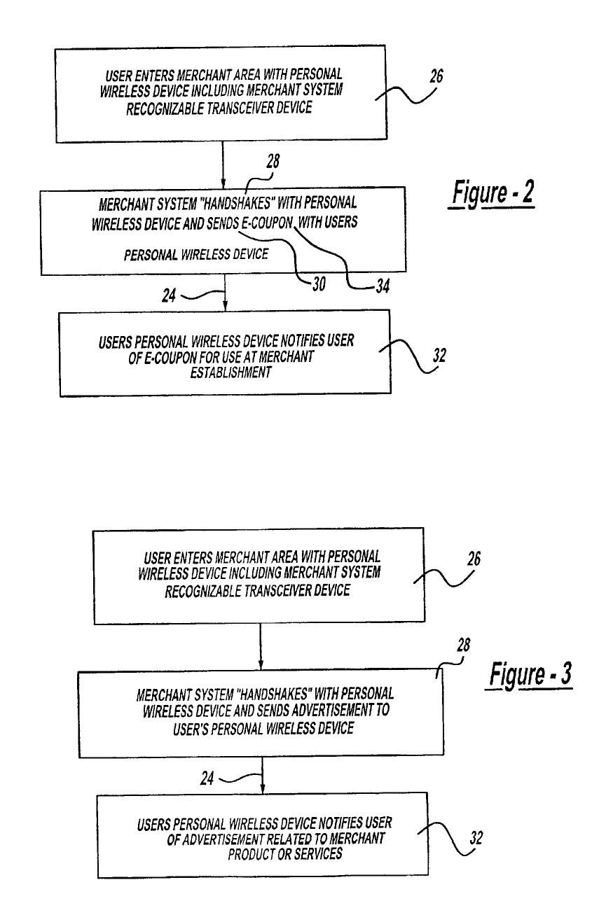

Having described the general elements of the system 10, attention is now turned to the method of the present invention. Referring now to FIG. 2, there is shown a first embodiment of the method of the present invention for providing an electronic communication 24 between a user 22 having a personal wireless device 12. The method includes step 26 of providing the personal wireless device with a transceiver device, step 28 of recognizing the presence of the personal wireless device transceiver 14. This recognition is commonly referred to in the industry as a “handshake”. This is accomplished through the utilization of current proximity communication technology. More specifically the radio transceiver 14 may be coupled with microchip technology built into the personal wireless device. The proximity communication technology makes communication instantly over existing wireless bandwidth. The proximity communication technology is fully functional without line of sight arrangements and has a normal range of 0 to 100 m. It has an optimal range of 0 to 50 meters.

The proximity communication technology is fully functional in noisy radio environments. The present invention contemplates using a proximity communication technology such as is commonly known in the industry as “Bluetooth”. The Bluetooth paper entitled “Bluetooth Protocol Architecture” authored by Thomas Mueller 1999-07-15 is herein incorporated by reference for a more specific explanation of the proximity communication technology. The present invention contemplates the use of any proximity communication technology which is capable of creating a “handshake” with a personal wireless device in a range from 0 to 1,500 meters to incorporate communication between the facility communication system and the personal wireless device. The range and sensitivity parameters are modifiable depending upon the size of the facility and the desire to also reach the user who may be just outside the facility.

As discussed above, the handshake can occur when the personal wireless device 12 is within a predetermined distance from the facility communication system 18 or when the user 22 enters the facility 16. In step 30, the facility communication system 18 sends a communication signal 24 to the personal wireless device 12. As will be discussed more specifically below, this communication signal, in the preferred embodiment maybe an e-coupon 34. FIG. 2 includes a farther step 32 of the personal wireless device 12 notifying the user 12 of the communication signal accepted by the device 12. This can be accomplished by activating various notifying means such as a ring, vibration of visual signal on the personal wireless device.

Referring now to FIG. 3, there is shown an alternative embodiment of the present invention. This method also includes step 26 of providing the personal wireless device with a transceiver device and step 28 of recognizing the presence of the personal wireless device transceiver 14. As in the first embodiment, this method also includes step 30, wherein the facility communication system 18 sends a communication signal 24 to the personal wireless device 12. In this embodiment, this communication signal, in the preferred embodiment may be an electronic advertisement 38. FIG. 3 also includes a further step 32 of the personal wireless device 12 notifying the user 12 of the communication signal accepted by the device 12.

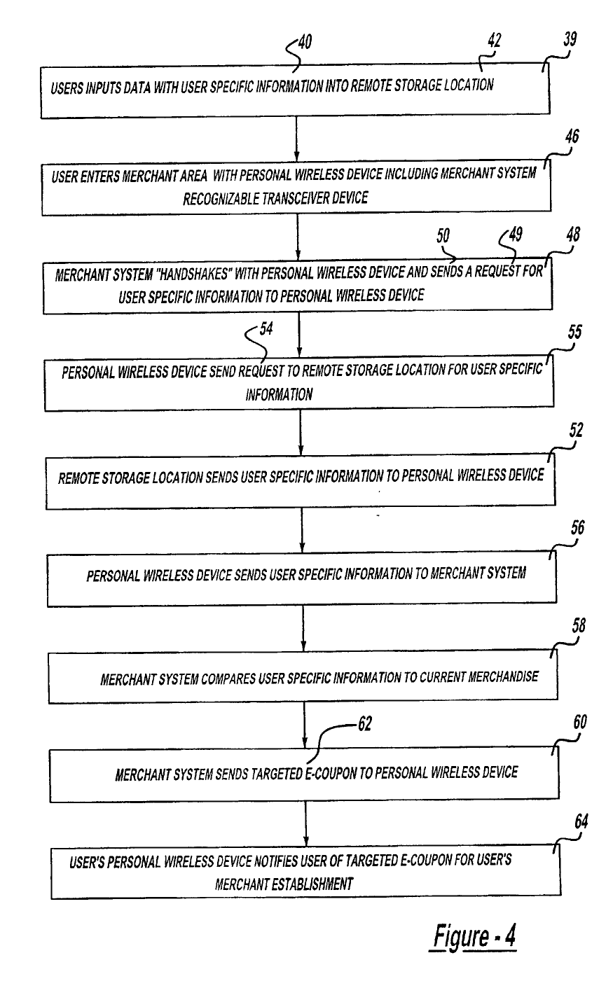

Referring now to FIG. 4, there is shown a third embodiment of the present invention, a method for a facility communication system to provide a targeted electronic communication to a user 22 having a personal wireless device 12. This method comprises the following steps. Initially, in step 39, the user 22 stores user specific information 40 in a storage location 42. This storage location may be a remote storage location 43 as shown in FIG. 1 or a personal wireless device resident storage location 44. The personal wireless device 12 is provided with a transceiver device 14 in step 46. The facility communication system 18 (merchant) handshakes or recognizes the presence of the personal wireless device transceiver when the personal wireless device is within a predetermined distance from the facility communication system in step 48. The facility communication system 18 send a request 47 for user specific information from the facility communication system 18 to the personal wireless device 12 in step 50.

The personal wireless device 12 retrieves the user specific information 40 in step 52. This is accomplished by sending a request 54 to the remote storage location 43 if the user specific information is stored remotely as in step 55. The user specific information may be retrieved directly from the personal wireless device 12 if the user specific information is stored at personal wireless device resident storage location 44. In step 56, the personal wireless device 12 sends the user specific information 40 to the facility communication system I S. In step 58, the facility communication system compares the user specific information 40 to predetermined criteria. The facility communication system, in step 60, sends a targeted electronic communication 62 to the personal wireless device 12 corresponding to the user specific information 40.

For example, user specific information 40 may be a user's shirt size, pant size, shoe size and color, fabric and style preferences. This user specific information, in step 58 is compared to predetermined criteria defined by the facility communication system. This criteria, is for example, current inventory levels for shirts, pants and shoes sizes corresponding to the user specific information. In addition, the color fabric and style preferences may also be compared along with the other information to define specific current merchandise that is present at the commercial establishment (merchant) while the user is in the facility. As noted above. the provision of user specific information when compared to the inventory criteria allows for targeted e-coupons to be provided. As in step 60, the targeted e-coupon is provided to the user which is specific and related directly to the user's specific predefined information 40. The user 22 shopping experience is enhanced because a real time confirmation is provided by the e-coupon that certain products exist within inventory that match the user's preferences. The present invention also contemplates this method with the use of less specific demographic information that is publicly available and capable of correlation to the user 22. FIG. 4 also includes a further step 64 of the personal wireless device 12 notifying the user 12 of the communication signal accepted by the device 12. The present invention further contemplates the redemption or utilization of the e-coupon 62 directly at the point of sale.

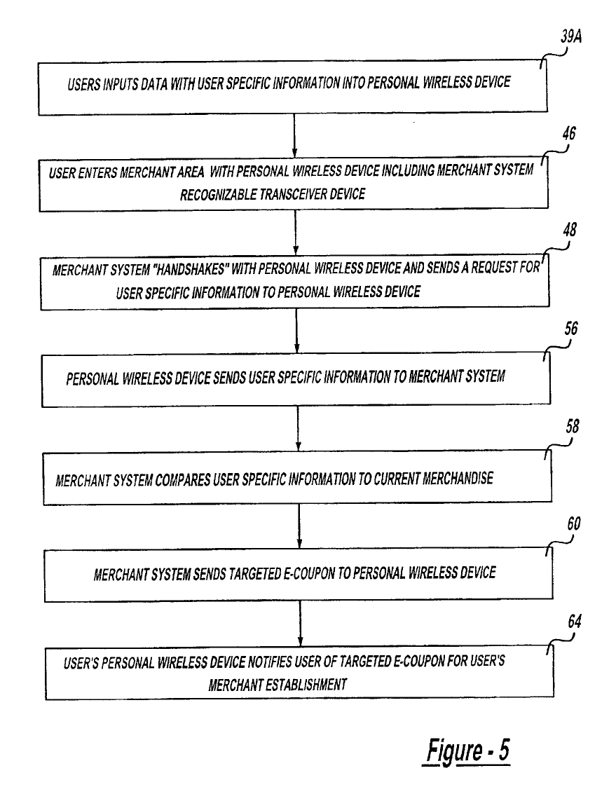

FIG. 5 illustrates more specifically the method of the present invention described above wherein the user specific information 40 is located or resident in the personal wireless device 12. The steps are as described above except that the user 22 inputs the user specific information directly into the personal wireless device 12 as shown in step 39a.

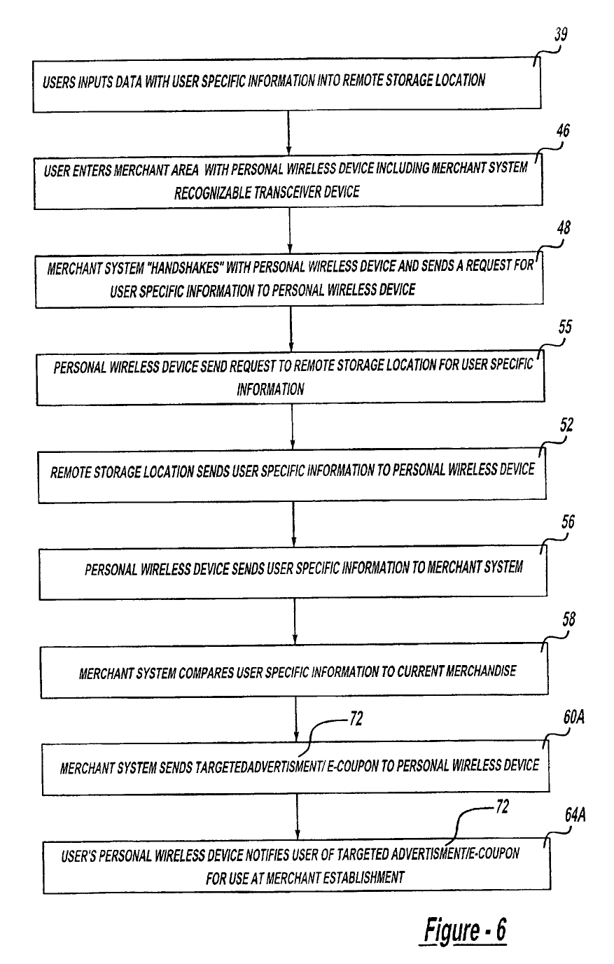

FIG. 6 illustrates an alternative embodiment of the present invention which is identical to FIG. 4 except that a targeted advertisement 72 is sent to the user 22 instead of a targeted e-coupon. As shown in FIG. 6, the steps are identical except step 60a which provides the targeted advertisement 72 and step 64a which notifies the user 22 of the targeted advertisement 72. As is commonly known, the advertisement 72 will include information and data about current sale items such as price, colors, sized etc., however as noted above, the present invention in using the targeted advertisement also provides the user 22 with specific information when compared to the inventory criteria. The targeted advertisement 72 is provided to the user which is specific and related directly to the user's specific predefined information 40. The user 22 shopping experience is also enhanced because a real time confirmation is provided by the advertisement 72 that certain products exist within inventory that match the user's preferences.

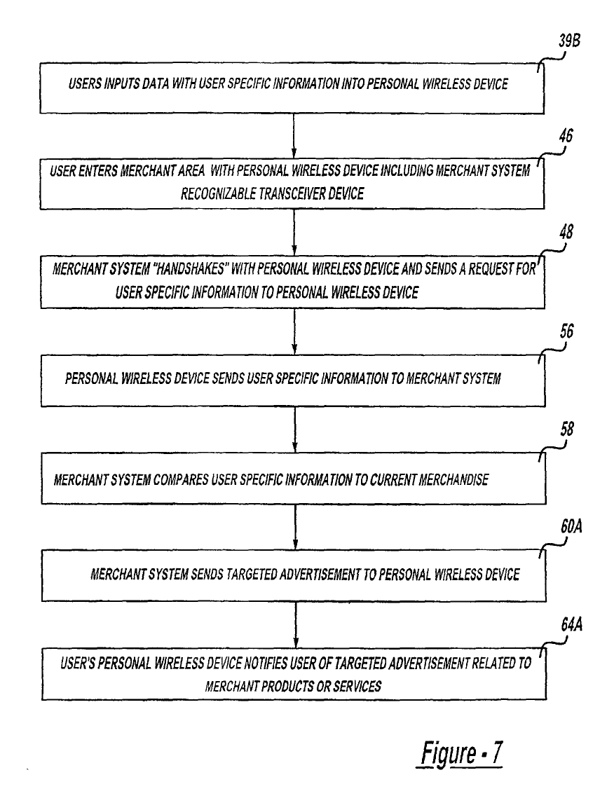

FIG. 7 illustrates more specifically the method of the present invention described above wherein the user specific information 40 is located or resident in the personal wireless device 12. The steps are as described above except that the user 22 inputs the user specific information directly into the personal wireless device 12 as shown in step 39b.

In conjunction with the embodiments described above, the present invention may utilized in a manner to obtain certain types of data from the user. More specifically, the present invention includes a method for obtaining information from a user having a personal wireless device. Using the system describes above, namely the existence of a facility communication system and a personal wireless device design providing the personal wireless device with a transceiver device capable of communication in a “handshake” manner, the following method is described. The facility communication system 18 recognized the presence of the personal wireless device 12 having transceiver 14 when the personal wireless device 12 is within a predetermined distance from the facility communication system 18. The facility communication system 18 sends a request for user specific information 40 to the personal wireless device 12. The facility communication system retrieves the user specific information and stores it form later review. The scope of the information obtained is directly related to the scope of information inputted by the user of obtainable about the user from a publicly available information network.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for providing an automatic electronic communication between a user and facility comprising:
a personal wireless device including a transceiver device; and
a facility communication system resident at said facility having a sensing device for recognizing the presence of said personal wireless device transceiver when the personal wireless device is within a predetermined distance from the facility communication system whereby said facility communication system sends a communication signal to the personal wireless device when said sensing device senses the presence of said personal wireless device.

2. The system of claim 1 wherein said personal wireless device creates a system notification for notifying said user that a communication signal has been received by said personal wireless device.

3. The system of claim 1 wherein said personal wireless device is a cellular phone.

4. The system of claim 1 wherein said personal wireless device is a pager.

5. The system of claim 1 wherein said personal wireless device is a personal digital assistant.

6. The system of claim 1 wherein said facility is a commercial establishment and said predetermined distance is entrance with said commercial establishment.

7. The system of claim 6 wherein said communication signal is an e-coupon for use at said commercial establishment.

8. The system of claim 6 wherein said communication signal is an advertisement providing data regarding said commercial establishment.

9. A system for providing a targeted electronic communication between a user and commercial establishment comprising:
a personal wireless device including a transceiver device; and
a facility communication system resident at said commercial establishment having a sensing device for recognizing the presence of said personal wireless device transceiver when the personal wireless device is within a predetermined distance from the facility communication system whereby said facility communication system sends a request for information to the personal wireless device when said sensing device senses the presence of said personal wireless device and said personal wireless device sends a response data message back to said facility communication system corresponding to said request for information and said facility communication system sends targeted electronic communication to said personal wireless device corresponding to response data message.

10. The system of claim 9 wherein said personal wireless device creates a system notification for notifying said user that a targeted communication signal has been received by said personal wireless device.

11. The system of claim 9 wherein said personal wireless device is a cellular phone.

12. The system of claim 9 wherein said personal wireless device is a pager.

13. The system of claim 9 wherein said personal wireless device is a personal digital assistant.

14. The system of claim 9 wherein said predetermined distance is entrance with said commercial establishment.

15. The system of claim 9 wherein said targeted communication signal is an e-coupon corresponding to the response data message for use at said commercial establishment.

16. The system of claim 9 wherein said targeted communication signal is an advertisement providing data corresponding to said response data message related to a product found at said commercial establishment.

17. A method for providing an electronic communication between a user having a personal wireless device and a facility communication system comprising the steps of.
providing the personal wireless device with a transceiver device;
recognizing the presence of the personal wireless device transceiver when the personal wireless device is within a predetermined distance from the facility communication system; and
sending a communication signal to the personal wireless device.

18. A method for a facility communication system to provide a targeted electronic communication to a user having a personal wireless device comprising the steps of:
storing user specific information in a storage location;
providing the personal wireless device with a transceiver device;
recognizing the presence of the personal wireless device transceiver when the personal wireless device is within a predetermined distance from the facility communication system;
sending a request for user specific information from the facility communication system to the personal wireless device;
retrieving the user specific information;
sending the user specific information from the personal wireless device to the facility communication system;
comparing the user specific information to predetermined criteria; and
sending a targeted electronic communication to said personal wireless device corresponding to the user specific information.

19. The method of claim 18 further including the step of notifying said user that a targeted electronic communication has been received by said personal wireless device.

20. The method of claim 18 wherein said step of storing user specific information in a storage location comprises storing the user specific information within said personal wireless device.

21. The method of claim 18 wherein said step of storing user specific information in a storage location comprises storing the user specific information at a remote storage location which is accessible by the personal wireless device.

22. The method of claim 21 wherein the step of retrieving the user specific information comprises retrieving the user specific information from said remote storage location.

23. The method of claim 18 wherein said personal wireless device is a cellular phone.

24. The method of claim 18 wherein said personal wireless device is a pager.

25. The method of claim 18 wherein said personal wireless device is a personal digital assistant.

26. The method of claim 18 wherein the step of recognizing the presence of the personal wireless device transceiver when the personal wireless device is within a predetermined distance from the facility communication system comprises recognizing the presence of the personal wireless device when the user enters a facility where the facility communication system is located.

27. The method of claim 18 wherein said facility communication system is located in a commercial establishment and said targeted communication signal is an e-coupon corresponding to the user specific information for use at said commercial establishment.

28. The method of claim 18 wherein said facility communication system is located in a commercial establishment and said targeted communication signal and said targeted communication signal is an advertisement providing data corresponding to said response data message related to a product found at said commercial establishment.

29. A method for obtaining information from a user having a personal wireless device, the method comprising the steps of:
providing a facility communication;
providing the personal wireless device with a transceiver device and a means for accessing user specific information;
recognizing the presence of the personal wireless device transceiver when the personal wireless device is within a predetermined distance from the facility communication system;
sending a request for user specific information from the facility communication system to the personal wireless device; and
retrieving the user specific information.

30. The method of claim 29 wherein said means for accessing user specific information is accessing the personal wireless device system and retrieving previously stored user specific information.

31. The method of claim 29 wherein said means for accessing user specific information is accessing by the personal wireless device a remote storage location having user specific information.

32. The method of claim 29 wherein said means for accessing user specific information is accessing a publicly available remote storage location having user specific information.

33. The method of claim 29 wherein said personal wireless device is a cellular phone

34. The method of claim 29 wherein said personal wireless device is a pager.

35. The method of claim 29 wherein said personal wireless device is a personal digital assistant.

36. The method of claim 29 wherein the step of recognizing the presence of the personal wireless device transceiver when the personal wireless device is within a predetermined distance from the facility communication system comprises recognizing the presence of the personal wireless device when the user enters a facility where the facility communication system is located.

37. The method of claim 29 wherein said facility communication system is located in a commercial establishment and said user specific information is demographic information.
